(19) United States
(12) Patent Application Publication
(10) Pub. No.: US 2025/0220730 A1
(43) Pub. Date: Jul. 3, 2025

(54) DISTRIBUTED RESOURCE UNITS IN COORDINATED ORTHOGONAL FREQUENCY-DIVISION MULTIPLE ACCESS

(71) Applicant: Cisco Technology, Inc., San Jose, CA (US)

(72) Inventors: Brian D. Hart, Sunnyvale, CA (US); Malcolm M. Smith, Richardson, TX (US); Matthew A. Silverman, Shaker Heights, OH (US); Binita Gupta, San Diego, CA (US)

(73) Assignee: Cisco Technology, Inc., San Jose, CA (US)

(21) Appl. No.: 18/785,981

(22) Filed: Jul. 26, 2024

Related U.S. Application Data
(60) Provisional application No. 63/616,568, filed on Dec. 30, 2023.

(51) Int. Cl. H04W 74/0833; H04L 5/00; H04W 28/02

(52) U.S. Cl. CPC H04W 74/085; H04L 5/0007; H04W 28/0278

(57) ABSTRACT

Distributed Resource Units (DRUs) in Coordinated Orthogonal Frequency-Division Multiple Access (C-OFDMA) may be provided. Using C-OFMA with DRUs can include determining to use with DRUs for a Transmit Opportunity (TXOP). Neighbor Access Point (AP) traffic information is requested from a neighbor AP, and the neighbor AP traffic information is received from the neighbor AP. A DRU assignment for the neighbor AP is determined based on the neighbor AP traffic information, and the DRU assignment is sent to the neighbor AP. Traffic is exchanged with one or more Stations (STAs) using C-OFDMA with DRUs during the TXOP, wherein the neighbor AP is operable to exchange neighbor AP traffic with one or more additional STAs during the TXOP using C-OFDMA with DRUs based on the DRU assignment.

### RELATED APPLICATION

Under provisions of 35 U.S.C. § 119 (e), Applicant claims the benefit of and priority to U.S. Provisional Application No. 63/616,568, filed Dec. 30, 2023, the disclosure of which is incorporated herein by reference in its entirety.

### TECHNICAL FIELD

The present disclosure relates generally to providing Distributed Resource Units (DRUs) in Coordinated Orthogonal Frequency-Division Multiple Access (C-OFDMA).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for implementing Distributed Resource Units (DRUs) in Coordinated Orthogonal Frequency-Division Multiple Access (C-OFDMA);

FIG. 2 is a block diagram of a signal process for implementing DRUs in C-OFDMA;

FIG. 3 is a flow chart of a method for implementing DRUs in C-OFDMA; and

FIG. 4 is a block diagram of a computing device.

### DETAILED DESCRIPTION

### Overview

Distributed Resource Units (DRUs) in Coordinated Orthogonal Frequency-Division Multiple Access (C-OFDMA) may be provided. Using C-OFMA with DRUs can include determining to use with DRUs for a Transmit Opportunity (TXOP). Neighbor Access Point (AP) traffic information is requested from a neighbor AP, and the neighbor AP traffic information is received from the neighbor AP. A DRU assignment for the neighbor AP is determined based on the neighbor AP traffic information, and the DRU assignment is sent to the neighbor AP. Traffic is exchanged with one or more Stations (STAs) using C-OFDMA with DRUs during the TXOP, wherein the neighbor AP is operable to exchange neighbor AP traffic with one or more additional STAs during the TXOP using C-OFDMA with DRUs based on the DRU assignment.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

For the Institute of Electrical and Electronics Engineers (IEEE) 802.11bn Ultra High Reliability (UHR) amendment, Low Power Indoor (LPI)-only clients and other clients that are constrained in some modes (e.g., a Physical Layer Protocol Data Unit (PPDU) with a narrow bandwidth), such as by a Power Spectral Density (PSD) regulatory limit, may have limited power available for operation. Distributed Resource Unit (DRU) techniques can be implemented to address the limited power issues of such clients. Given regulations typically limit the transmit power allowed per one Megahertz (MHz). When using DRU, a client ideally transmits at most one OFDM tone per one MHz instead of multiple tones per MHz (e.g., about 12.8 tones per MHz in typical implementations). Thus, devices can use DRU to increase the power of the tones since there is only one tone per one MHz for each device. For example, the one tone of the DRU implementation will have approximately thirteen times the power of an implementation that includes about 12.8 tones per MHz, and the one tone of the DRU implementation will have gains as much as eleven decibels of link budget (i.e., 10*log(12.8)=11 decibels approximately).

Implementing DRU, however, can degrade system throughput and cause other issues. For example, implementing DRU can be wasteful of the available spectrum and, can create interference for client devices. Particularly, DRU can be reasonably implemented for many active users but may be wasteful of the available spectrum when there is a low number of users (e.g., one user, two users, three users, etc.). When there is a low number of users, each transmission may occupy tenfold or higher additional spectrum than the transmission would otherwise need. Additionally, DRU can cause interference between adjacent co-channel Basic Service Sets (BSSs) because the power of transmission may be tenfold (e.g., thirteen times more) more concentrated at certain frequencies. Methods and systems are described for supporting DRU in Coordinated Orthogonal Frequency-Division Multiple Access (C-OFDMA) to reduce or eliminate the possible issues DRU can cause.

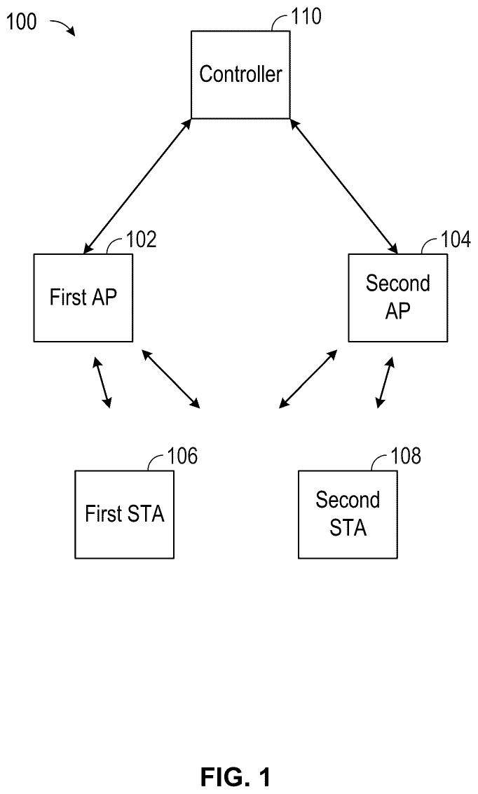

FIG. 1 is a block diagram of an operating environment 100 for implementing DRUs in C-OFDMA. The operating environment 100 can include a first AP 102, a second AP 104, a first Station (STA) 106, a second STA 108, and a controller 110. The first AP 102 and the second AP 104 may enable devices, such as the first STA 106 and the second STA 108, to connect to the network. The first STA 106 and the second STA 108 can be any device that connects to the network to communicate with other devices on the network, such as a smart phone, a tablet, a personal computer, a server, and/or the like. The controller 110 may be any network controller (e.g., a Wireless Local Area Network (WLAN) controller) and may manage the first AP 102, the second AP 104, and/or other network devices to allow wireless devices to connect to the network. The operations of the controller 110 may be performed by one or more of the first AP 102 and the second AP 104, whereby there may be no physically separate controller, in some embodiments and vice versa. For example, one of the first AP 102 or the second AP 104 may be a primary or leader AP that controls the other APs or otherwise instructs the other APs how to operate. The leader AP may be the AP that is assigned or otherwise controlling a current Transmit Opportunity (TXOP). The operating environment 100 is an example configuration and there may be a different number of APs, controllers, and/or other devices in further examples.

The first AP 102 and the second AP 104 may use C-OFDMA with DRUs when communicating with the first STA 106 and/or the second STA 108. Using DRUs can include using standard (sometimes referred to as regular) Resource Units (RUs) and/or Multiple RUs (MRUs). If DRU is supported on two APs in range of each other, such as the first AP 102 and the second AP 104, the first AP 102 and the second AP 104 may always use or otherwise enable C-OFDMA with DRUs. In other embodiments, the first AP 102 and the second AP 104 may be required to support C-OFDMA when using DRUs to communicate to reduce or eliminate potential issues that usage of DRU can cause (e.g., wasting available spectrum, interference, etc.). For example, the first AP 102, the second AP 104, and/or the controller 110 may determine using DRUs will or is likely to cause issues based on the number of devices the first AP 102 and the second AP 104 are communicating with to determine that C-OFDMA should be required. There may be a threshold for requiring the use of C-OFDMA with DRUs in some example implementations. For example, when transmitting using DRUs and/or triggering the use of DRUs by STAs with a percentage of the devices connected to the associated AP and/or other devices of the network, there will be an associated percentage of tones being occupied (i.e., gaps between subcarriers). C-OFDMA may be required if the percentage of tones being occupied is under the threshold (e.g., fifty percent or lower).

Supporting C-OFDMA may be required for one or both of Downlink (DL) (i.e., AP to STA communications) and triggered Uplink (UL) (i.e., STA to AP communications). A triggered UL may be any UL communication triggered by a DL communication by an AP that also indicates the AP is supporting C-OFMDA for DRU, but the first STA 106 and the second STA 108 may determine whether an AP supports C-OFDMA with DRUs without a DL communication in other examples. Thus, if the first AP 102 or the second AP 104 sends a transmission with DRU, the first AP 102 or the second AP 104 must support C-OFMDA for DRU.

The first AP 102 and the second AP 104 may communicate between each other to determine C-OFDMA with DRU capabilities and enable using C-OFDMA with DRU in some examples. In other embodiments, the first AP 102 and the second AP 104 may communicate with the controller 110 to indicate C-OFDMA with DRU capabilities, and the controller 110 can determine when the first AP 102 and the second AP 104 should enable C-OFDMA with DRU. When C-OFDMA with DRU is enabled, a leader AP (e.g., the first AP 102) with an assigned TXOP, especially if the AP's planned transmission has many unoccupied tones, can determine whether a neighbor AP (e.g., the second AP 104) has traffic to send and/or receive and assign DRU resources during the TXOP to the neighbor AP if there is traffic.

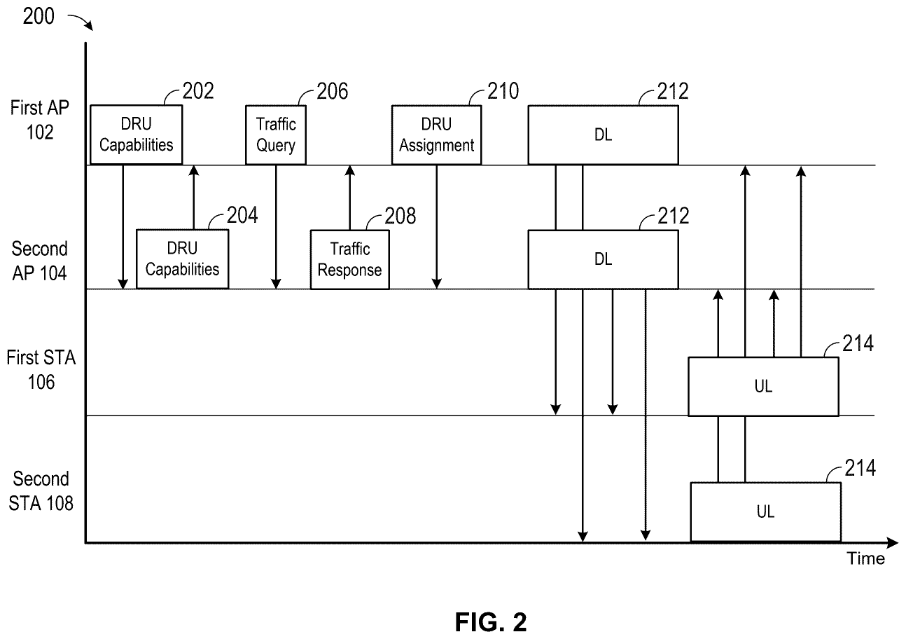

FIG. 2 is a block diagram of a signal process 200 for implementing DRUs in C-OFDMA. The signal process 200 may include communications between the first AP 102, the second AP 104, the first STA 106, and the second STA 108 in this example. However, other devices may communicate during the signal process 200 in other examples. For example, three or more APs may perform C-OFDMA with DRUs during the signal process 200 with one or more STAs. In example implementations, the controller 110 may communicate with the first AP 102 and the second AP 104 to determine C-OFDMA with DRU capabilities, instruct the first AP 102 and the second AP 104 to enable C-OFDMA with DRU, and/or the like.

The signal process 200 may begin with the first AP 102 and the second AP 104 signaling their C-OFDMA with DRU capabilities. The first AP 102 may send a first C-OFDMA with DRU capability signal 202 to the second AP 104, and the second AP 104 may send a second C-OFDMA with DRU capability signal 204 to the first AP 102. The first C-OFDMA with DRU capability signal 202 may indicate to the second AP 104 that the first AP 102 is capable of using C-OFDMA with DRU. Similarly, the second C-OFDMA with DRU capability signal 204 may indicate to the first AP 102 that the second AP 104 is capable of using C-OFDMA with DRU. The first AP 102 and the second AP 104 may advertise or otherwise transmit that the first AP 102 and the second AP 104 are C-OFDMA with DRU capable to any neighbor AP, so multiple APs may receive the signals in further examples. APs may send C-OFDMA with DRU capability signals simultaneously, in response to receiving a C-OFDMA with DRU capability signal, and/or the like.

For a TXOP associated with the signal process 200, a leader AP may be assigned or otherwise associated with the TXOP. The first AP 102 is the leader AP in this example. As the leader AP, the first AP 102 may determine to use DRU during the TXOP and identify that the first AP 102 should use C-OFDMA with DRU. For example, the first AP 102 may determine that the traffic it has to transmit and/or receive is below a threshold of tone occupation (e.g., less than twenty percent, less than fifty percent, less than eighty percent, or the like). In response to determining that the first AP 102 should use C-OFDMA with DRU, the first AP 102 may send a traffic query signal 206 to the second AP 104 and/or any other neighbor APs that are C-OFDMA with DRU capable. The traffic query signal 206 may request the second AP 104 to respond with neighbor AP traffic information—information associated with traffic the second AP 104 wants to send and/or receive that may be exchanged during the TXOP (e.g., requesting an AP-to-AP Buffer Status Report (BSR) identifying queued traffic, requesting an indication of whether the second AP 104 can make use of the available resources or not, etc.). An AP-to-AP BSR can include aggregate information for associated STAs, UL information, DL information, delay information, buffered bytes, and/or the like. For example, the BSR can include one or more measures of a number of buffered octets, separated or not by DL and UL, Traffic Identifier (TID), flow, and/or the like, one or more measures of latency or expiry imminence of buffered octets, separated or not by DL and UL, TID, flow, and/or the like, and so on.

Once the second AP 104 receives the traffic query signal 206, the second AP 104 may respond with a traffic response 208 indicating information associated with the traffic that the second AP 104 wants to send and/or receive, such as via a BSR. The first AP 102 may then evaluate the information associated with the traffic the second AP 104 wants to send and/or receive to determine whether to assign DRUs to the second AP 104 for transmission and/or reception, such as for of at least a portion of the traffic during the TXOP. The first AP 102 may then inform the second AP 104 of which DRUs the second AP 104 is assigned with a DRU assignment signal 210. The DRU assignment signal 210 may also be a trigger for the second AP 104 to begin to use of the assigned DRUs during the TXOP, or the first AP 102 may send a separate trigger signal.

In some embodiments, the first AP 102 and/or the second AP 104 may have DL traffic to send to the first STA 106 and/or the second STA 108. The first AP 102 and/or the second AP 104 may therefore transmit DL signals 212 to the first STA 106 and/or the second STA 108. For example, the first AP 102 may transmit the DL signal(s) 212 to the first STA 106 using C-OFDMA with DRUs the first AP 102 determined to use, and the second AP 104 may transmit the DL signal(s) 212 to the second STA 108 using C-OFDMA with DRUs the first AP 102 assigned (i.e., as indicated by the DRU assignment signal 210).

In some embodiments, the first AP 102 and/or the second AP 104 may have UL traffic to receive from the first STA 106 and/or the second STA 108. The first AP 102 and/or the second AP 104 may therefore receive UL signals 214 from the first STA 106 and/or the second STA 108. For example, the first AP 102 may receive the UL signal(s) 214 from the first STA 106 using C-OFDMA with DRUs the first AP 102 determined to use, and the second AP 104 may receive the UL signal(s) 214 from the second STA 108 using C-OFDMA with DRUs the first AP 102 assigned (i.e., as indicated by the DRU assignment signal 210).

The signal process 200 may include different signals and/or a different order in other examples. For example, the first AP 102 and/or the second AP 104 may transmit trigger frames to the first STA 106 and/or the second STA 108 to trigger UL communications, the first AP 102, the second AP 104, the first STA 106, and/or the second STA 108 may exchange Acknowledge (ACK) frames, such as Bock ACK frames, to indicate that communications are received, and/or the like. Additionally, the first AP 102 and/or the second AP 104 may transmit zero or more DL signals 212, and the first STA 106, and/or the second STA 108 may transmit zero or more UL signals 214. The DL signals 212 and/or the UL signals 214 may also be transmitted in a different order, simultaneously, and/or the like.

In additional TXOPs, the second AP 104 may be assigned or otherwise in control of the TXOP and act as the leader AP. Thus, the second AP 104 may transmit a traffic query signal 206 to the first AP 102, the first AP 102 may transmit a traffic response 208, the second AP 104 may transmit a DRU assignment signal 210, etc. Further, once the first AP 102 and the second AP 104 exchange the first C-OFDMA with DRU capability signal 202 and the second C-OFDMA with DRU capability signal 204, the first AP 102 and the second AP 104 may not need to re-exchange signals to determine C-OFDMA capability signals for later TXOPs. The first AP 102 and the second AP 104 can therefore utilize C-OFDMA with DRU in further TXOPs without repeating the indication of DRU capabilities. Thus, a TXOP may begin with the leader AP of the TXOP determining to use DRU, transmitting a traffic query, a DRU assignment message, and/or the like to initiate a TXOP for C-OFDMA with dRU with one or more C-OFDMA with DRU capable neighbors.

In some embodiments, the first AP 102 and/or the second AP 104 may signal the presence of periodic traffic that use regular bursts and the scheduling parameters corresponding to the periodic traffic. Then, the traffic query signal 206 and the traffic response 208 may be omitted for TXOPs used for the periodic traffic because the first AP 102 and the second AP 104 know when the periodic traffic is going to occur based on the scheduling parameters. For example, the second AP 104 can indicate traffic for one or more upcoming TXOPs, including periodic traffic via the traffic response 208.

In some embodiments, the signal process 200 may be performed in a single TXOP. In other embodiments, the signal process 200 may be performed only partially in a TXOP. For example, the first AP 102 and the second AP 104 may exchange the first C-OFDMA with DRU capability signal 202 and the second C-OFDMA with DRU capability signal 204 before a TXOP for communicating with STAs (e.g., the first STA 106 and the second STA 108) to reserve the time available in the TXOP for the communications with the STAs. Additionally or alternatively, the AP may determine to use C-OFDMA with DRUs, transmit the traffic query signal 206, and receive the traffic response 208 before the TXOP to reserve the time available in the TXOP for the communications with the STAs. The AP may transmit the traffic query signal 206, and receive the traffic response 208 before the TXOP using out of band signaling in some embodiments. Thus, the DRU assignment signal 210, the DL signals 212, and/or the UL signals 214 may be exchanged during the TXOP.

Other communications may be present in further example embodiments. For example, there may be additional communications between the first AP 102 and the second AP 104 after the second AP 104 transmits the DRU capability signal 204 and before the first AP 102 transmits the traffic query signal 206. There may be additional communications between the first AP 102 and the second AP 104 after the first AP 102 transmits the traffic query signal 206 and before the second AP 104 transmits the traffic response 208 in some example implementations.

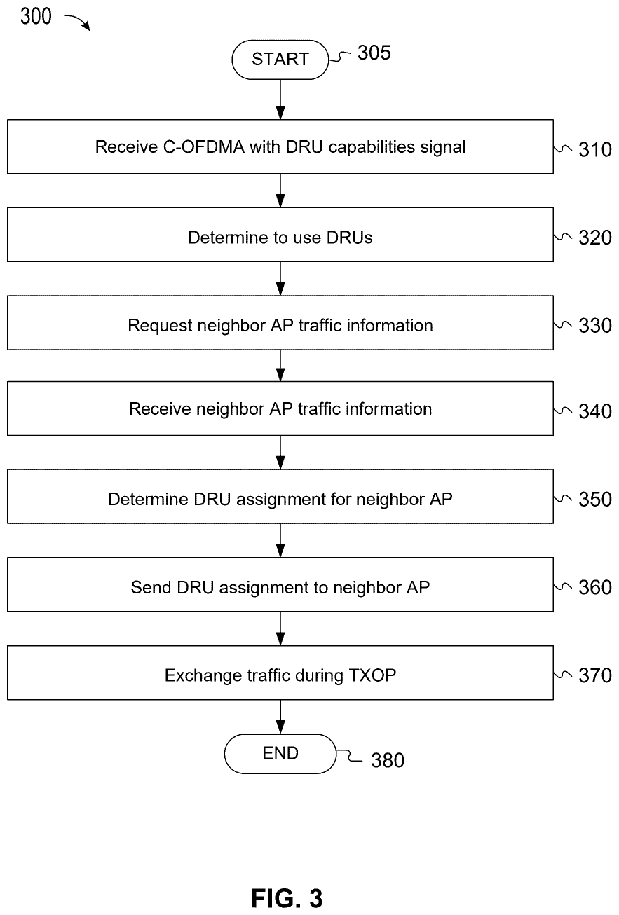

FIG. 3 is a flow chart of a method 300 for implementing DRUs in C-OFDMA. The method 300 may begin at starting block 305 and proceed to operation 310. In operation 310, a C-OFDMA with DRU capability signal may be received from the neighbor AP indicating the neighbor AP is capable of using C-OFDMA with DRUs. For example, the first AP 102 may receive the second C-OFDMA with DRU capability signal 204 from the second AP 104. The first AP 102 may also send the first C-OFDMA with DRU capability signal 202 to the second AP 104 in some embodiments.

In operation 320, it is determined to use DRUs for a TXOP. For example, the first AP 102 may be a leader AP for a TXOP and determine to use DRUs during the TXOP. Determining to use DRUs can include the first AP 102 determining whether traffic for exchange (e.g., transmission to one or more STAs and/or reception from one or more STAs) during the TXOP is below a threshold of tone occupation (e.g., ratio, percentage, etc.). If so, the first AP 102 determines to use C-OFDMA with DRUs. If the traffic for exchange is not below the threshold, the first AP 102 may determine to not use C-OFDMA with DRUs.

In operation 330, neighbor AP traffic information is requested from a neighbor AP. For example, the first AP 102 may send the traffic query signal 206 to the second AP 104 or otherwise request the second AP 104 to send traffic information. The first AP 102 may request neighbor AP traffic information for any number of APs that the first AP 102 may enable to exchange traffic during the TXOP.

In operation 340, the neighbor AP traffic information is received from the neighbor AP. For example, the first AP 102 receives the traffic response 208 from the second AP 104 or otherwise receives the neighbor AP traffic information from the second AP 104. In some examples, the neighbor AP traffic information comprises a BSR. In some embodiments, operation 310, operation 320, operation 330, and/or operation 340 are all performed before the TXOP. In some embodiments, operation 330 and operation 340 may be omitted, such as when the present TXOP follows an earlier TXOP that includes operation 330 and/or operation 340.

In operation 350, a DRU assignment for the neighbor AP is determined based on the neighbor AP traffic information. For example, the first AP 102 determines a portion of the available DRUs during the TXOP for the second AP 104 to use. The first AP 102 may also select another portion of the available DRUs during the TXOP to use for traffic of the first AP 102. When the first AP 102 determines to enable multiple neighbor APs to exchange traffic during the TXOP, the first AP 102 may determine a DRU assignment for each neighbor AP. In operation 360, the DRU assignment is sent to the neighbor AP. For example, the first AP 102 sends the DRU assignment signal 210 to the second AP 104 or otherwise sends the DRU assignment to the second AP 104.

In operation 370, traffic with one or more STAs is exchanged using C-OFDMA with DRUs during the TXOP, wherein the neighbor AP is operable to exchange neighbor AP traffic with one or more additional STAs during the TXOP using the DRU assignment. For example, the first AP 102 may use the selected DRUs for the traffic of the first AP 102, and the second AP 104 may use the assigned DRUs for the traffic of the second AP 104. The one or more APs and the one or more additional APs may include one or more of the same STAs or include different STAs. Thus, the first AP 102 and the second AP 104 may exchange traffic with one or more STAs during the TXOP (e.g., the first STA 106 and/or the second STA 108), including one or more of the same STAs in some examples. The traffic and the neighbor AP traffic can be UL communications and/or DL communications. The method 300 may conclude at ending block 380.

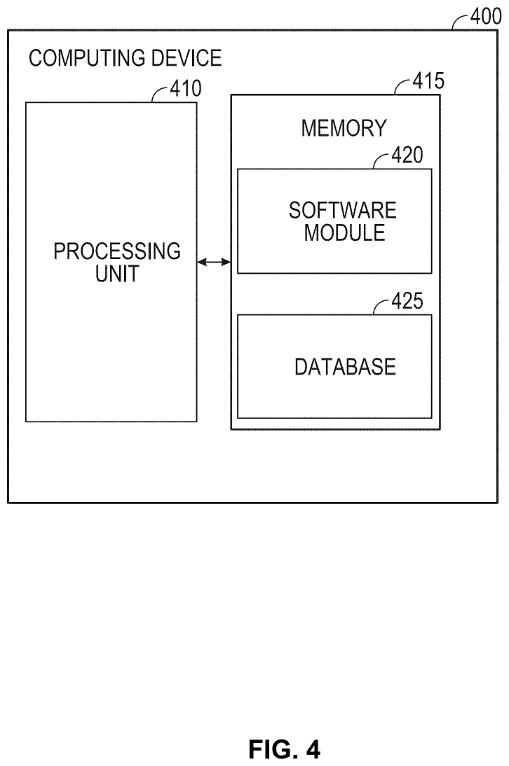

FIG. 4 is a block diagram of a computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for using C-OFDMA with DRUs with respect to FIG. 1, FIG. 2, and FIG. 3. Computing device 400, for example, may provide an operating environment for the first AP 102, the second AP 104, the first STA 106, the second STA 108, the controller 110, and the like. The first AP 102, the second AP 104, the first STA 106, the second STA 108, the controller 110, and the like may operate in other environments and are not limited to computing device 400.

Computing device 400 may be implemented using a Wi-Fi AP, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining to use Distributed Resource Units (DRUs) for a Transmit Opportunity (TXOP);
requesting neighbor Access Point (AP) traffic information from a neighbor AP;
receiving the neighbor AP traffic information from the neighbor AP;
determining a DRU assignment for the neighbor AP based on the neighbor AP traffic information;
sending the DRU assignment to the neighbor AP; and
exchanging traffic with one or more Stations (STAs) using Coordinated Orthogonal Frequency-Division Multiple Access (C-OFDMA) with DRUs during the TXOP, wherein the neighbor AP is operable to exchange neighbor AP traffic with one or more additional STAs during the TXOP using C-OFDMA with DRUs based on the DRU assignment.

2. The method of claim 1, further comprising:
receiving a C-OFDMA with DRU capability signal from the neighbor AP indicating the neighbor AP is capable of using C-OFDMA with DRUs.

3. The method of claim 1, wherein determining to use DRUs comprises determining that the traffic for exchange during the TXOP is below a threshold of tone occupation.

4. The method of claim 1, further comprising:
selecting a portion of available DRUs during the TXOP, wherein exchanging the traffic with the one or more STAs using C-OFDMA with DRUs comprises using the portion of available DRUs.

5. The method of claim 1, wherein the traffic and the neighbor AP traffic is any one of (i) Downlink (DL) communications, (ii) triggered Uplink (UL) communications, or (iii) a combination of (i) and (ii).

6. The method of claim 1, wherein the neighbor AP traffic information comprises a Buffer Status Report (BSR).

7. The method of claim 1, wherein determining to use DRUs, requesting neighbor AP traffic information from the neighbor AP, and receiving the neighbor AP traffic information from the neighbor AP are before the TXOP.

8. A system comprising:
a memory storage; and
a processing unit coupled to the memory storage, wherein the processing unit is operative to:
determine to use Distributed Resource Units (DRUs) for a Transmit Opportunity (TXOP);
request neighbor Access Point (AP) traffic information from a neighbor AP;
receive the neighbor AP traffic information from the neighbor AP;
determine a DRU assignment for the neighbor AP based on the neighbor AP traffic information;
send the DRU assignment to the neighbor AP; and
exchange traffic with one or more Stations (STAs) using Coordinated Orthogonal Frequency-Division Multiple Access (C-OFDMA) with DRUs during the TXOP, wherein the neighbor AP is operable to exchange neighbor AP traffic with one or more additional STAs during the TXOP using C-OFDMA with DRUs based on the DRU assignment.

9. The system of claim 8, the processing unit being further operative to:
receive a C-OFDMA with DRU capability signal from the neighbor AP indicating the neighbor AP is capable of using C-OFDMA with DRUs.

10. The system of claim 8, wherein to determine to use DRUs comprises to determine that the traffic for exchange during the TXOP is below a threshold of tone occupation.

11. The system of claim 8, the processing unit being further operative to:
select a portion of available DRUs during the TXOP, wherein exchanging the traffic with the one or more STAs using C-OFDMA with DRUs comprises using the portion of available DRUs.

12. The system of claim 8, wherein the traffic and the neighbor AP traffic is any one of (i) Downlink (DL) communications, (ii) triggered Uplink (UL) communications, or (iii) a combination of (i) and (ii).

13. The system of claim 8, wherein the neighbor AP traffic information comprises a Buffer Status Report (BSR).

14. The system of claim 8, wherein to determine to use DRUs, request neighbor AP traffic information from the neighbor AP, and receive the neighbor AP traffic information from the neighbor AP are before the TXOP.

15. A non-transitory computer-readable medium that stores a set of instructions which when executed perform a method executed by the set of instructions comprising:
determining to use Distributed Resource Units (DRUs) for a Transmit Opportunity (TXOP);
requesting neighbor Access Point (AP) traffic information from a neighbor AP;
receiving the neighbor AP traffic information from the neighbor AP;
determining a DRU assignment for the neighbor AP based on the neighbor AP traffic information;
sending the DRU assignment to the neighbor AP; and
exchanging traffic with one or more Stations (STAs) using Coordinated Orthogonal Frequency-Division Multiple Access (C-OFDMA) with DRUs during the TXOP, wherein the neighbor AP is operable to exchange neighbor AP traffic with one or more additional STAs during the TXOP using C-OFDMA with DRUs based on the DRU assignment.

16. The non-transitory computer-readable medium of claim 15, the method executed by the set of instructions further comprising:
receiving a C-OFDMA with DRU capability signal from the neighbor AP indicating the neighbor AP is capable of using C-OFDMA with DRUs.

17. The non-transitory computer-readable medium of claim 16, the method executed by the set of instructions further comprising:
sending a second C-OFDMA with DRU capability signal to the neighbor AP.

18. The non-transitory computer-readable medium of claim 15, the method executed by the set of instructions further comprising:
selecting a portion of available DRUs during the TXOP, wherein exchanging the traffic with the one or more STAs using C-OFDMA with DRUs comprises using the portion of available DRUs.

19. The non-transitory computer-readable medium of claim 15, wherein determining to use DRUs comprises determining that the traffic for exchange during the TXOP is below a threshold of tone occupation.

20. The non-transitory computer-readable medium of claim 15, wherein determining to use DRUs, requesting neighbor AP traffic information from the neighbor AP, and receiving the neighbor AP traffic information from the neighbor AP are before the TXOP.
